(19) United States
(12) Patent Application Publication
(10) Pub. No.: US 2010/0045928 A1
(43) Pub. Date: Feb. 25, 2010

(54) FASHION EYEWEAR FRAME THAT HOUSES CIRCUITRY TO EFFECT WIRELESS AUDIO COMMUNICATION WHILE PROVIDING EXTRANEOUS BACKGROUND NOISE CANCELLATION CAPABILITY

(75) Inventor: Isaac Levy, Lawrence, NY (US)

Correspondence Address: HESS PATENT LAW FIRM, P.C., 9 MIRAMAR LANE, STAMFORD, CT, 06902, US

(73) Assignee: TRI-SPECS, INC., Lawrence, NY (US)

(21) Appl. No.: 12/545,928

(22) Filed: Aug. 24, 2009

Related U.S. Application Data
(60) Provisional application No. 61/091,590, filed on Aug. 25, 2008.

(51) Int. Cl. G02C 11/00

(52) U.S. Cl. 351/158

(57) ABSTRACT

An eyewear with communications capability to pair with a Bluetooth enabled device and equipped with noise cancellation software. The earpieces are connected to a retraction wheel by a flexible cord. The cord winds about the wheel to retract the earpiece and unwinds to extend the earpiece to its operative position. A retractable button may be pressed to urge the retraction wheel to rotate to wind the cord about it under spring force.

### CROSS-REFERENCE TO PENDING PATENT APPLICATION

This application claims the benefit of priority from U.S. provisional patent application Ser. No. 61/091,590 filed Aug. 25, 2008 and whose contents are incorporated herein by reference.

### BACKGROUND OF THE INVENTION

1. Field of the Invention

The present invention relates to fashion eyewear whose frame houses circuitry. The circuitry provides wireless audio communication capability with remote devices and provides cancellation of extraneous background noise in the wireless audio communication with respect to extraneous background noise present in the vicinity of the fashion eyewear.

The circuitry includes at least two microphones and at least one speaker. The speaker may be pulled from a retracted position to a pulled-out position where, as part of an earpiece or earstem, it is positioned at the ear. A spring bias may be engaged to retract the speaker back into the retracted position.

2. Discussion of Related Art

U.S. Pat. No. 6,729,726 and U.S. Pat. No. 7,313,246 each provide in connection with their disclosure of eyewear:

Additional microphones are used in some embodiments to improve sound pickup quality. Such additional microphones are placed in various positions, such as on the same earstem, the opposite earstem, or on a frame supporting the lenses. The use of more than one microphone in various positions to improve sound pickup directionality allows the wearer's voice to be sensed more clearly and extraneous background noises to more easily be canceled. Consequently, enhanced directionality improves performance of, for example, voice recognition software executed by digital signal processors described below, and improves the quality of the wearer's voice for remote conversation or for recording as dictation.

Noise cancellation software is commercially available (e.g., from Texas Instruments, Incorporated), and modification of such software for this application is easily accomplished in light of this-disclosure.

Upon placing microphones on the same earstem, on the opposite earstem, or nn a frame supporting the lenses, such placement renders the microphone visible externally on the eyewear so as to take away from the fashion statement otherwise made by the eyewear. That is, the microphone is not supposed to be part of the aesthetics for the consumer appeal of the fashion eyewear, but is forced to be there since it is on the eyewear, as opposed being hidden by the eyewear.

It would be desirable to provide fashion eyewear whose frame hides the wireless Bluetooth communication circuitry substantially from view and yet provide superior noise cancellation capability to cancel out extraneous background noise to thereby provide quality voice pickup of the wearer.

The present inventor presented at the 2008 Consumer Electronics Show in Las Vegas, Nev., a prototype of fashion eyewear frame in accordance with the invention that houses or recesses within at least two microphones and that has noise cancellation software to cancel extraneous background noise to thereby provide quality voice pickup of the wearer. The following are exemplary accolades from media covering the show:

San Francisco Chronicle (Jan. 9, 2009)
GADGET OF THE DAY At the Consumer Electronics Show
Bluetooth-enabled shades
Chronicle technology reporter Ryan Kim's pick from this week's Consumer Electronics Show in Las Vegas:

TriSpecs sunglasses, which have extendable earpieces at the ends of the arms. Use one or both buds to listen to music via Bluetooth from your MP3 player or talk on the phone. The earpieces retract with the push of a button. Two microphones near the hinges provide good sound quality. Control buttons are on the arms. One charge lasts five to seven hours. The glasses will go on sale in the next few months for $199.

FOXNEWS.COM HOME>SCITECH
Seven Cool Gadgets Best of Consumer Electronics Show:

January 6: Trispecs sunglasses, which have wireless stereo headphones and Bluetooth headset functionality at CES in Las Vegas. Listen to your iPod and look stylish without wires.

Cell Phone News 2.0 Phone Area

The 2009 CES at Las Vegas is indeed seeing tremendous mobile and mobile-related activity. The latest offering from Tri-Specs at the pre-press event ‘2009 CES Unveiled’ is Bluetooth-enabled eyewear. This product claims to combine the best acoustic sound with noise cancellation for providing the user with a superior voice quality experience with premium stereo MP3 sound, using buttons on the arms of the eyeglasses.

These Bluetooth-enabled glasses from Tri-Specs are stylish looking and uses STEP Labs' superior acoustic technology with dual mics, dual speakers and Bluetooth connectivity in a small mobile accessory. The other features of this device include voice-dialing, one-touch activation of phone calls, call control buttons on the arms of the glasses and MP3 playback. This product is available in white, black and metallic colors.

NY 1 Living Jan. 7, 2009 02:42 PM
Las Vegas Tech Show Unveils Fresh Gadgets Of '09 By: Adam Balkin

Convergence is also expected to be a major theme, as more and more devices do things one might not necessarily expect them to do, like “bluetooth sunglasses.”

“You can pair the glasses to your phone and an mp3 player,” says Isaac Levy of Tri-Specs, Inc. “You can listen to music in stereo wirelessly and take and receive calls at the same time and we have phenomenal noise cancellation. It does not pick up any of the surrounding noise or wind.”

CBS NEWS EARLY SHOW

Blending high fashion sunglasses, stereo headphones, and Bluetooth headset functionality, TriSpecs are a hot way to connect to mobile phones and music players. TriSpecs' engineering enables the user to switch between voice communication methods with STEP Labs' unsurpassed voice separation audio technology and acoustically enhanced stereo sound for a great music experience using button controls on the glasses.

PC World

CES Unveiled, a media event held Tuesday that showcases winners of the CES Innovations awards, proved that this annual gadgetfest continues to be a launching pad. We saw everything from a Bluetooth headset that looks like a big earring to an Internet tablet that helps hearing-impaired users stay in touch . . .

TriSpecs glasses connect to your phone or other mobile device via Bluetooth, then let you listen to music or talk on the phone via discreet earpieces and mic (can you even see those on the models' glasses?). The people at the TriSpecs booth say their product (which starts at $199 and zooms upward if you want, say prescription lenses) delivers high-end audio quality while seamlessly transferring you from music to calls on the paired cell phone.

Trends Updates: CES2009 Trispecs Sunglasses Negate the Need for Headphones

If you wanted to combine fashion with technology you must consider the Trispecs Sunglasses, which look almost like designer sunglasses. However, the sunglasses also double up as wireless stereo headphones and also as a Bluetooth headset. Now that is what I call innovation. The product was featured at the CES 2009, and the product stood out among the hundreds of products unveiled there.

The sunglasses come with noise eliminating technology and dual microphones and speakers. The sunglasses come for both men and women and in many colours and styles. It also supports voice dialing and prompting and hence encourages hands free usage.

The sunglasses also feature voice communication, which is only short of being a full fledged iPhone or some other snazzy communication device like that. The price is not known yet. Looks like one fine day we won't require any gadgets we can just go ahead and use clothes and accessories for even telepathy.

Tri-Specs Shows TriSpecs Bluetooth Eyeglasses at CES By Editor Wireless and Mobile News on Jan. 7, 2009 1:05 PM

Tri-Specs is showing Bluetooth-enabled sunglasses for MP3 players and mobile phones at CES. They tagline is “Where high tech meets high fashion.”

TriSpecs High Tech Sunglasses

TriSpecs are eyeglasses with dual microphones and volume controls for MP3 players and cell phones.

TriSpecs integrate patented STEPvoice software from STEP Labs for noise cancellation. STEPvoice uses the physics of sound propagation to define the shape and arrival time of sound waves to isolate voice signals from undesired noises

STEP Labs' software is able to tell the difference between the wearer's voice and other voices, sounds, and noises, preserving the natural fidelity of the voice and producing near-perfect voice recognition performance, and noise cancellation.

Chip Chick CES 2009: Trispecs Designer Stereo Bluetooth Sunglasses

We can't help but be reminded of Oakley's similar bluetooth sunglasses. Putting that aside, these Trispecs Sunglasses look promising. They are a pair of “designer” sunglasses that also work as wireless stereo headphones and a bluetooth headset. They feature noise elimination acoustic technology, dual microphones and dual speakers. The sunglasses are available in a variety of features, styles and colors—including female specific versions. Yay!

Feature Run down: *Power turns on by extending the in-ear speakers *Voice prompts and voice dialing for easy, hands-free use *Instant, dynamic volume to compensate for noise changes in the environment *Retractable standard earpiece speakers or upgrade with in-ear barrel speakers *One-touch activation of phone calls * MP3 and call control buttons on the arms of the glasses *Available in black, white, and metallic with optional designs and style elements.

Coolest Gadgets http://www.coolest-gadgets.com/20090115/tri-specs-all-in-one-shades-and-headphones/

While I was at CES Unveiled, I managed to see a product that I probably would have missed on the showfloor called the Tri-Specs. Tri-Specs are Bluetooth wireless headphones for an MP3 Player or cellular phone that are in the form of sunglasses.

At the ends of the Tri-Specs are two retractable earpieces that the user can put in his or her ears, which automatically turn the Tri-Specs on when extended. The best part is that no one would ever know that you are wearing earpieces while you wear the Tri-Specs glasses. You could be listening to MP3s while you're supposed to be listening to the human resources director talk about some needless thing. Unless they look closely, your supervisors would never know.

The phone and volume controls are located conveniently on one side of the frame, and the MP3 controls are on the other side. In addition to the manual controls, the Tri-Specs can also accept voice commands with the STEPvoice software that can recognize the user's voice from others, as well as outside noises.

I was amazed at the design of the shades, because fashion was not sacrificed for functionality. In other words, the sunglasses look like actual sunglasses and not an MP3 Player pretending to be sunglasses.

The Tri-Specs should be available now for a price of $199.99, in colors of black, white, silver, blue, black metallic, as well as black and white combo.

Consumer Electronics Daly News Jan. 10, 2009

High Tech Meets High Fashion With TriSpecs

Finally, Bluetooth technology is breaking out of its shell. Consumer's have only known Bluetooth to mean something you wear on the ear to talk on a mobile phone. Yet many of us here at CES have always known that Bluetooth technology is much more than that—it has the potential to be a liberating, cord cutting, connect everything technology.

That's why we're excited to see a new Bluetooth accessory that is more than a mobile phone earpiece—TriSpecs™.

TriSpecs' sunglasses are a Bluetooth accessory that pairs fashion with technology in ways that every Bluetooth earpiece-wearing person always wanted—something that actually looks good and is easy to use.

TriSpecs' sunglasses are a combo fashion accessory, cell phone accessory and MP3 accessory which use Bluetooth technology lo allow the wearer to seamlessly move back and forth between voice calls with layers of new technology to produce unsurpassed voice quality and high-fidelity stereo sound.

TriSpecs patents and engineering deliver intuitive controls allowing for a simple user experience. The device is powered on and off by the retractable earpieces; place one or both of the earpieces in your ear and you're running. Buttons on one arm control phone calls while the other arm controls music players. Good looks, ease of control and unparalleled noise reduction software all in one accessory—it's about time!

The technology hidden inside the frames of the glasses does the rest of the work. TriSpecs uses STEP Labs™ cutting-edge acoustic technology to provide better voice and sound quality than have heard before.

To get superior voice quality TriSpecs chose STEPvoice™. STEP Voice uses advanced acoustic technology to distinguish voice and noise signals and then uses proprietary Digital Signal Processing (DSP) to transmit only the voice signals to the phone. This kind of DSP was originally developed for DARPA (Defense Advanced Research Projects Agency), which creates and delivers technology for the U.S. military—so you know it's got to be good.

TriSpecs also implemented STEP Labs' technology in the speakers. We all know that as surrounding noise increases, the intelligibility of incoming speech is greatly compromised. Because these sunglasses use STEPsound™, which dynamically adjusts speaker volumes according to background noise levels, speech intelligibility in these glasses is outstanding.

But don't take our word for it; try them for yourself in STEP Labs' booth North 931. We can guarantee you will be as impressed with their looks as you will be with their acoustic design.

### SUMMARY OF THE INVENTION

One aspect of the invention resides in a device with any number of the following capabilities:

a) Switching between voice communication and stereo music with the push of a button to connect, for instance, to mobile phones and music players.

b) Carrying out the voice communication without interference from background noise by using background noise cancellation technology.

c) Blending designer sunglasses, stereo headphones, and headset functionality that uses low-power radio communications to wirelessly link phones, computers and other network devices over short devices with Bluetooth technology to support simple wireless networking of personal consumer devices and peripherals, including cell phones, PDAs, and wireless headsets.

d) Pressing the same button to answer an incoming call, to hang-up, and to trigger making a call with a call-by-voice feature or with a call initiating feature of the phone.

e) Receiving high quality stereo music streamed wirelessly from a phone or MP3 payer, yet pausing the music if an incoming call is received while the wearer is listening to the streamed music to allow the wearer to hear a preset ring tone and either answer or ignore the incoming call after which the music is resumed from where it left off.

### BRIEF DESCRIPTION OF THE DRAWING

For a better understanding of the present invention, reference is made to the following description and accompanying drawings, while the scope of the invention is set forth in the appended claims:

FIG. 1 shows an isometric view of fashion eyewear in accordance with the invention equipped with Bluetooth wireless communication capability and noise cancellation software.

FIG. 2 shows an isometric view of the eyewear as in FIG. 1 but undergoing battery charging.

FIG. 3 shows an isometric view of the eyewear as in FIG. 1, but with a right earpiece pulled out.

FIG. 4 shows an isometric view of a portion of the right temple bar of the eyewear of FIG. 1 to provide an enlarged view of the control buttons.

FIG. 5 shows an isometric view of a portion of the left temple bar of the eyewear of FIG. 1 to provide an enlarged view of the control buttons.

FIG. 6 shows a schematic isometric representation of the eyewear of FIG. 1, but with the outer skin of the frame removed to show the electrical circuitry and mechanical components within the frame and temple bars.

FIG. 7 shows an isometric view with an alternative earpiece with earplug.

FIG. 8 shows an exploded, isometric view of a microphone and housing used in the eyewear of FIGS. 1-7.

FIG. 9 shows an isometric view of fashion eyewear in accordance with a further embodiment of the invention equipped with Bluetooth wireless communication capability and noise cancellation software and that has a detachable distal part of a temple bar.

FIG. 10 shows an isometric view of the fashion eyewear of FIG. 9, but with one of the earpiece frame portions detached from the rest of the eyewear.

FIG. 11 shows an isometric view of the fashion eyewear of FIG. 9, but with the outer skin of the frame removed to show the electrical circuitry and mechanical components within the frame and temple bars.

### DETAILED DESCRIPTION OF THE INVENTION

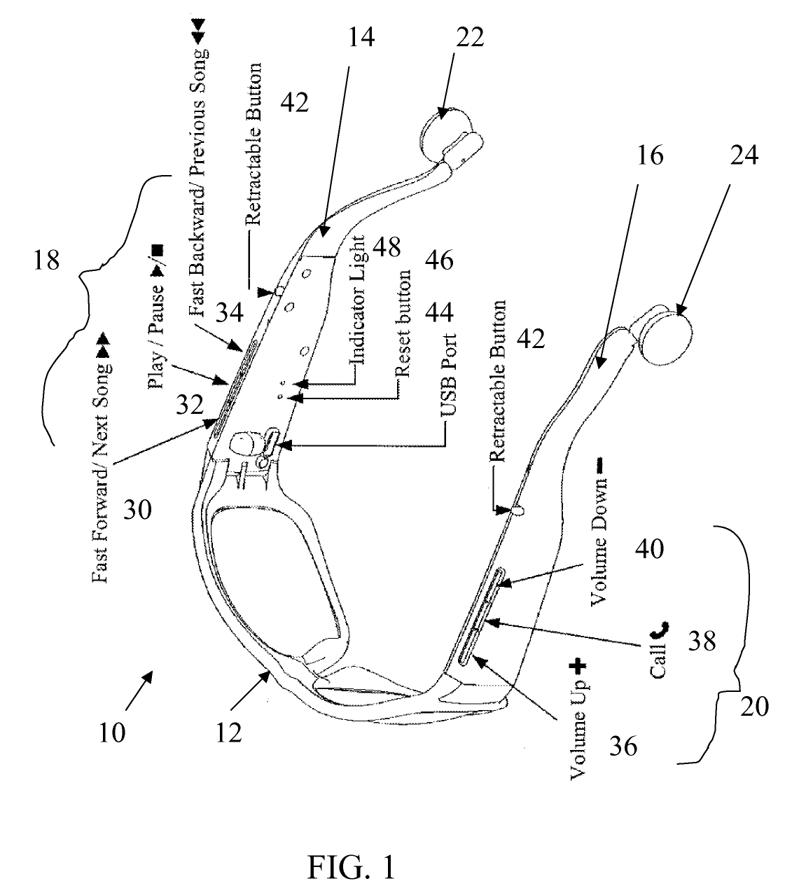

Turning to FIGS. 1-5, the eyewear 10 includes a lens frame 12, which holds lenses preferably made of spherical polycarbonate with impact resistance and 400 nm UV protection, such as that commercialized by Carl Zeiss Vision. Preferably, the lens frame is Rx compatible for prescription lenses. The eyewear 10 also has two temple arms 14, 16 each equipped with respective button controls 18, 20 and a respective retractable earpiece 22, 24 that has a speaker.

The button controls 18 may be MP3 controls to which high quality stereo music is streamed wirelessly from a phone of MP3 player. If a call is received while listening to music, the song is paused and the wearer hears a preset ring tone. The incoming call may be answered or ignored and the music resumes thereafter from where it left off just prior to the pause. The button controls 18 include three buttons: a fast forward/next song button 30, a play/pause button 32 and a fast/backward/previous song button 34.

The button controls 20 may be phone/volume controls that include a call button and volume control buttons. To answer a call, press the call button. To hang up, press the same call button again. To make a call, either press the same call button and use a call-by-voice feature (to trigger the calling by verbal commands) or make the call with the phone as one normally does. The button controls 20 include three buttons: a volume up button 36, a call button 38, a volume down button 40.

Both temple arms 14, 16 are hinged to the lens frame 12 in a conventional manner and each has an associated retractable button 42. The earpieces 22, 24 may be freely pulled outward to reached their extended position. By pressing the associated retractable button 42, the earpiece 22, 24 at the same temple arm 14, 16 will return under spring bias to its fully retracted position if it is free to retract. The temple arm 14 may also have a USB port 44, a reset button 46 and an indicator light 48.

The USB port 44 functions is a conventional manner in the same way that conventional USB ports function. By inserting a tip to press against the reset button 46, which is recessed, the manufacturer default settings for the eyewear may be restored. The indicator light 48 is also recessed with LED(s), and may flash as a steady red light, a flashing red light, a flashing green light or a flashing amber light.

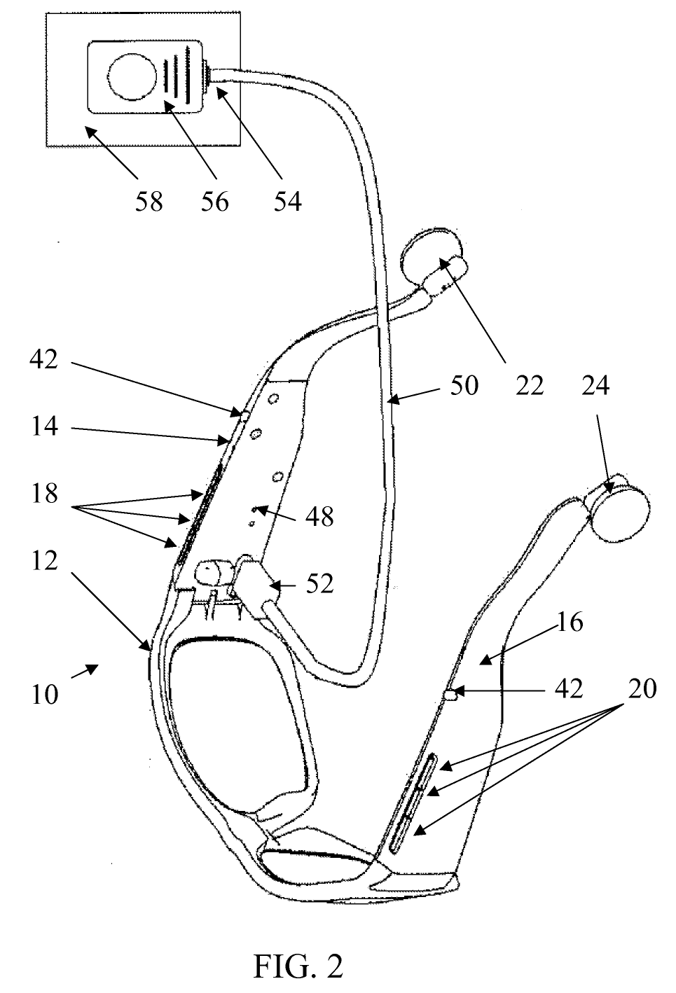

Preferably, the battery selected to power the eyewear 10 provides over 70 hours of standby time, up to 7 hours of talk time or 5 hours of music playback time when fully charged. The charge the battery in the eyewear, power may be provided through a micro USB connector cable 50 either from a USB port of a computer or from an electrical wall outlet (see FIG. 2). If the USB port of the computer is to be used, engage a socket end 52 into the USB port 42 and plug the connector at the opposite plug end 54 into the USB port of the computer. If the electrical wall outlet is to be used, plug the connector at that same opposite end of the micro USB connector cable 50 into a bundled adaptor 56 before plugging the adaptor 56 into the electrical wall outlet 58. When the battery needs charging, the indicator light 48 will flash red. While the battery charging is ongoing, the indicator light 48 will turn a stead red. The indicator light may turn off when the battery is fully charged.

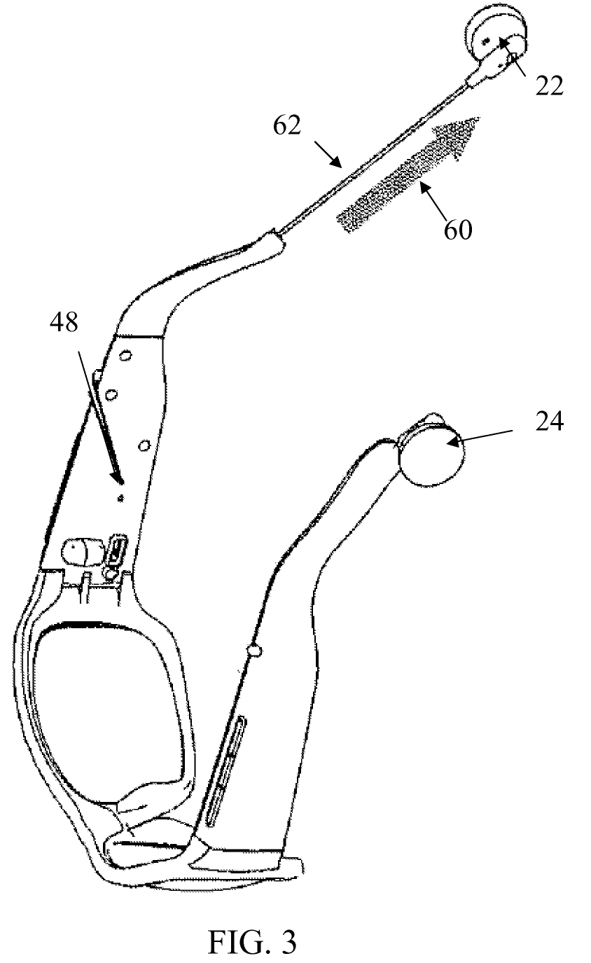

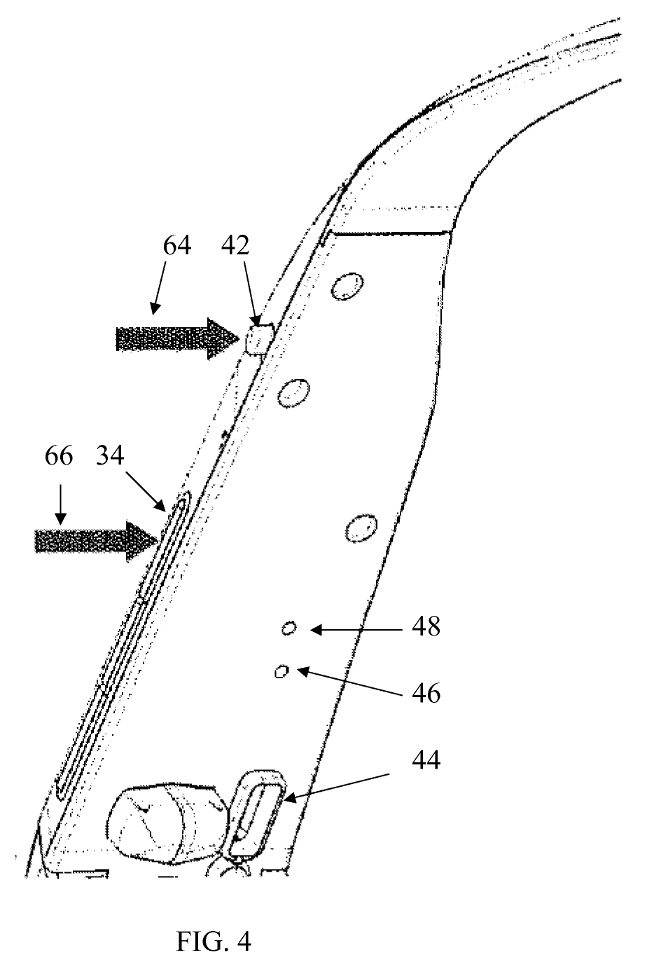

To turn on the eyewear 10, pull down the right earpiece in the direction of the arrow 60 to its extended position (see FIG. 3), which exposes the flexible cord 62 containing a communication line and a power line to the associated earpiece. A voice prompt “Hello” will be heard and the indicator light 48 should flash from red to amber to green to green. To turn the eyewear off (see FIG. 4), press and hold the fast backward/previous song button 34 in the direction of arrow 66 and then press the right retractable button 42 of the temple arm 14 in the direction of arrow 64. A voice prompt “Goodbye” will be heard and the indicator light 48 should flash from green to amber to red to red. To mute the microphone 82, press and hold the volume down button 40 until the voice prompt “Muted” is heard. Repeat the procedure to release from mute when the voice prompt “un-mute” is heard. When communication between the eyewear 10 and the phone/music device is interrupted, such as when the eyewear is out of range, the eyewear 10 will attempt to re-establish the connection, If reestablishing connection is unsuccessful after 10 minutes, the eyewear 10 will turn off.

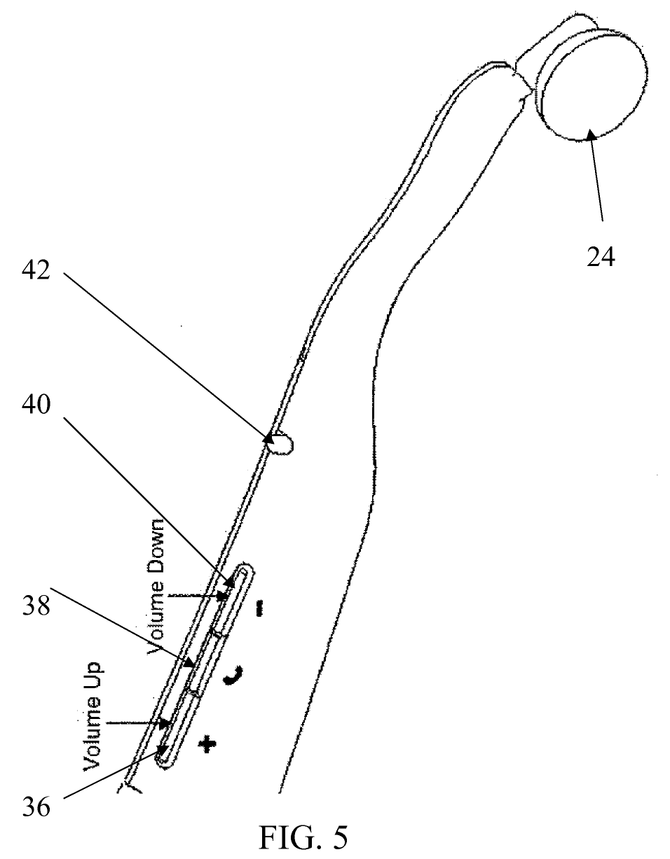

Turning to FIG. 5, the volume up button 36 and the volume down button 40 may be used on the left temple arm 16 to adjust the volume. To increase the speaker volume, press the volume up button 36 repeatedly until the desired volume is achieved. To decrease the speaker volume, press the volume down button 40 repeatedly until the desired volume is achieved. When adjusting the speaker volume while the eyewear is in phone mode, a single high-pitch tone will be heard when the maximum or minimum volume level is reached. When adjusting the speaker volume in the music mode, the single high-pitch tone will not be provided.

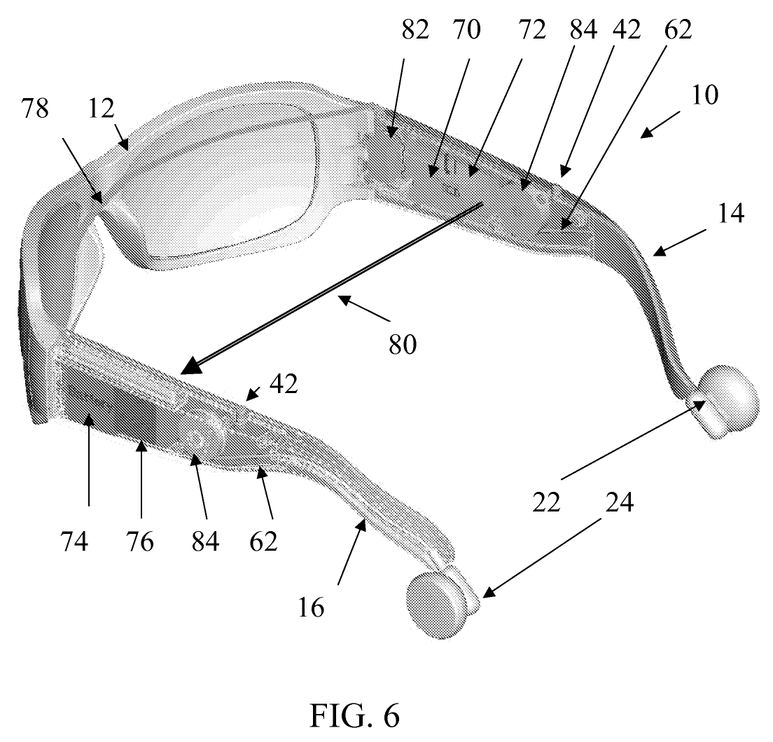

Turning to FIG. 6, the electrical circuitry within the eyewear 10 can be seen. The right temple bar 14 contains a printed circuit board 70 that contains all the circuitry necessary to serve as an MP3 player to playback music. An integrated circuit transmitter 70 is provided to transmit Bluetooth signals 80 in a wireless manner that can be picked up by a receiver 66 and/or a receiver in close proximity, such as that of another Bluetooth-compatible device, exemplified by a cell phone. The receiver 76 picks up Bluetooth signals also from a nearby Bluetooth-compatible device.

A battery 74 provides power to the receiver 76 and provides power to the printed circuit board 70 and integrated circuit transmitter via a main flex line 78 that passes through or along the lens frame 12 between the two temple bars 12, 14. The battery 74 may be replaceable and/or rechargeable via the USB port or by induction. The battery 74 also provides power to the microphone 82 on the printed circuit board 60 and to each of the earpieces 22, 24 via the main flex 78. The main flex may also serve as a communication line to convey communication signals from the receiver 76 to the earpiece 22.

Also shown is a retraction wheel 84 in each temple bar 14, 16 that winds or unwinds an associated flexible cord 62 that connects with an associated earpiece 22, 24. Each retraction wheel is spring biased to urge the associated flexible cord to wind about the wheel when freed to do so from pressing a nearby retractable button 42. The principle of operation is the same as for appliances having retractable power cords that retract when a button is pressed, but which may be manually pulled out.

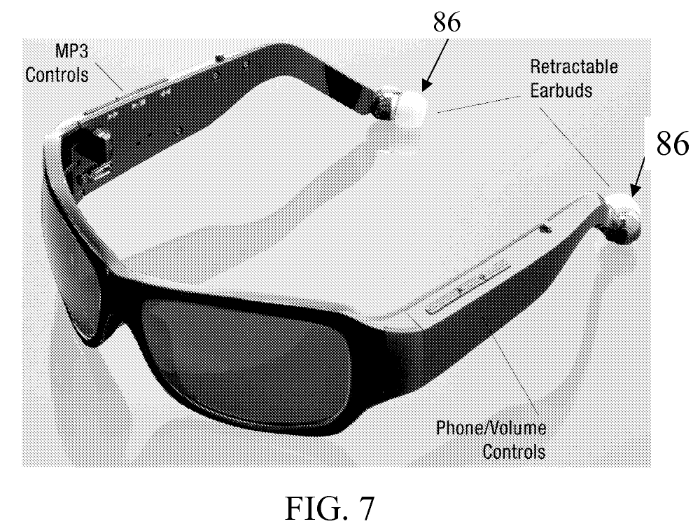

FIGS. 1-6 shows the earpieces with hemispherical speakers. Turning to FIG. 7, the speakers may instead be smaller and located at a distal end of a cylindrical extension, which in turn is fitted on its exterior by a resilient, flexible, tubular earplug 86. The feel of the earplug 86 may be more comfortable to wearers in the ear than the hemispherical speakers of FIGS. 1-6. One might expect that the earplug 86 provides an added benefit of dampening or reducing the level of ambient sounds (extraneous background noise) to improve sound clarity of he earpieces. However, the noise cancellation software, which is provided by StepLabs (now owned by Dolby Sound), is sufficient to eliminate any noise interference otherwise arising from ambient sounds. The earplug 86 may be used repeatedly and never need replacement unless damaged. That is, the earplug 86 Is not intended for disposal.

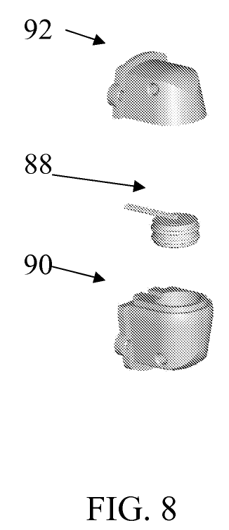

FIG. 8 shows the assembly of the microphone 82. It includes the microphone 88 contained within two housing parts 90, 92 that mate each other.

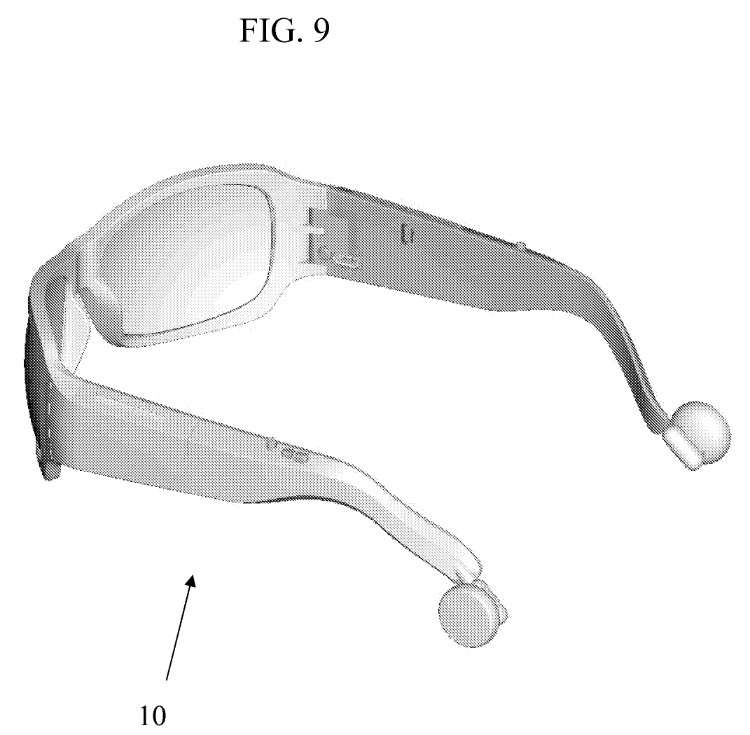

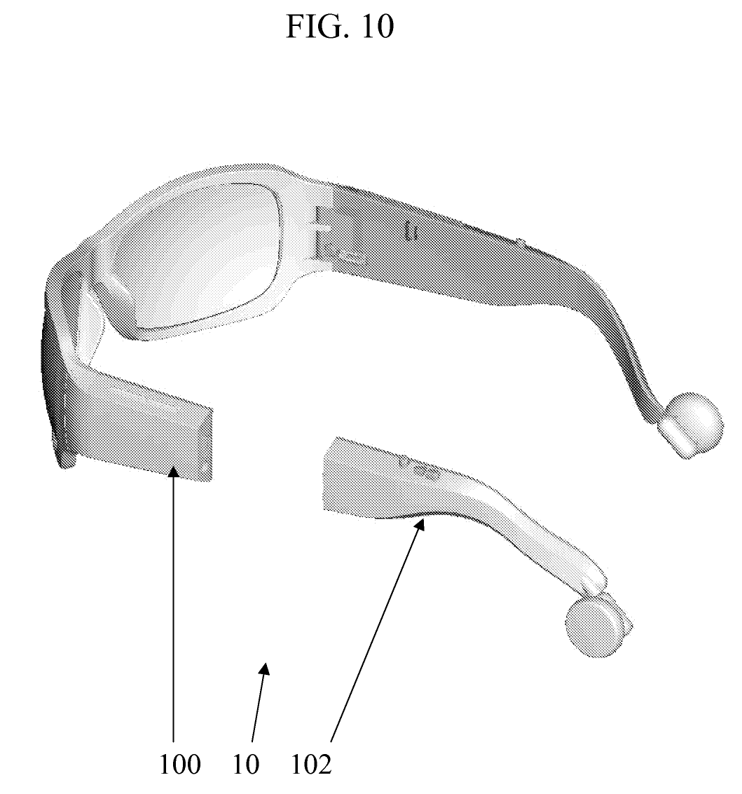

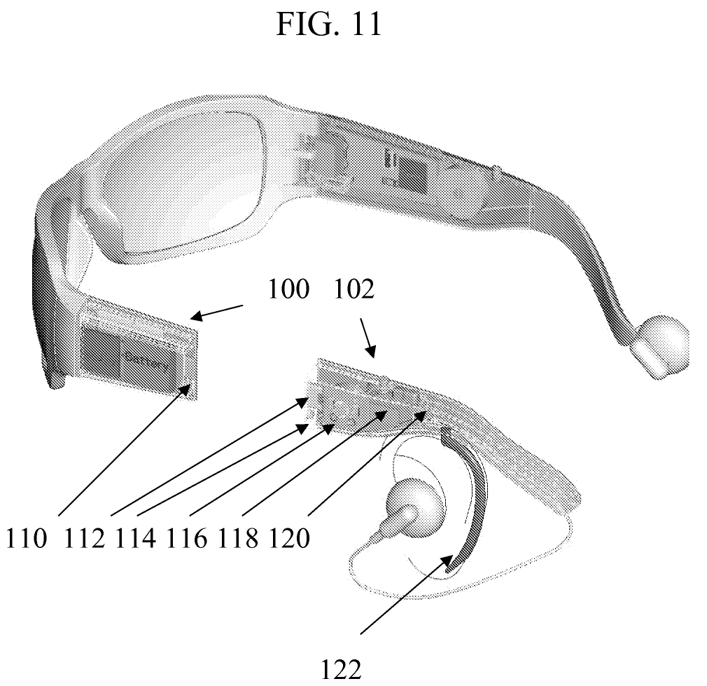

FIGS. 9-11 show a further embodiment in which a distal part of one of the temple bars is detachable apart from the rest of the eyewear and operable independent of the rest of the eyewear or in conjunction when attached. FIG. 9 shows the appearance of the eyewear 10 prior to detachment. FIG. 10 shows the appearance of the eyewear 10 after detachment of a distal part 102 from the proximal part 100 of a temple bar. FIG. 11 shows the internals of the eyewear 10.

All the internals are the same as those of FIG. 6, except as follows. There are mating connectors 110, 112 that join with each other or detach from each other as desired. One connector 110 extends from the proximal part 100 while the other connector 112 extends from the distal part 102. The distal part 102 also has its own microphone 114, printed circuit board 116 with an integrated circuit receiver, a secondary battery cell 118 and buttons 120 for making and receiving calls independent of the rest of the eyewear 10. Also, a detachable ear hook 122 should be worn about the periphery of the ear to help keep the distal part 102 in position retained by the ear. As in the previous embodiments, the distal part has a retraction wheel and resilient, flexible cord that winds ono or unwinds from the retraction wheel to position the earpiece either extended into the ear canal or into its retracted position.

In each of the embodiments, the eyewear needs to be paired with a Bluetooth enabled device, such as a phone and/or a music device. Preferably, the device supports the following:

Bluetooth advanced audio distribution profile (A2dP) for wireless audio streaming and Bluetooth audio/video remote control profile (AVRCP) for wireless control of music. To pair the Bluetooth enabled eyewear of the present invention with such a Bluetooth enabled device (e.g., phone/music device):

Turn on the Bluetooth feature of the phone/music device, turn on the eyewear 10 of the present invention by pulling down the right hand side speaker 22 (see FIG. 3) and hold the call button 38 (FIG. 5) until the indicator light 48 (FIG. 4) turns red. Search for Bluetooth devices using the phone/music device and select EYEWEAR from the list of discovered devices from the phone/music device. Follow onscreen prompts to confirm the selection. When prompted, enter a passkey, such as four zeros. When pairing is successful, the indicator light flashes green four times and the voice prompt “pairing successful” is heard. The eyewear is ready for use.

The eyewear 10 can store pairing information for up to eight different phone/music devices. Once pairing is established, the eyewear 10 will connect to the last connected device each time it turns on and is within range. For instance, pressing the call button 38 will connect the eyewear to the phone that it was last in connection. Pressing the Play/pause button 32 will connect the eyewear to the music device that the eyewear was last in connection. To connect to a different device in its memory list of paired devices, the connection from that different device to the eyewear 10 is initiated first. Two different types of music/phone devices can be wirelessly connected to the eyewear at the same time (such as a phone and an MP3 player), but two similar devices (such as two phones) cannot be connected to the eyewear at the same time.

The eyewear 10 is programmed to have a handsfree profile, a headset profile and a controlling music profile.

The handsfree profile includes pressing and holding the call button 38 to reject a call, redial last dialed number, put a call on hold, or answer a second incoming call. The handsfree profile also includes making a short press of the call button 38 and speaking the name or command to dial by voice, making a short press of the call button 38 while the call is connected to transfer the call from the phone to eyewear, pressing the call button 38 twice to transfer the call from the eyewear to the phone, pressing the call button 38 and the volume up button 36 to continue current call while rejecting the second incoming call, and pressing the call button 38 and the volume down button 40 to end the current call and answer the second incoming call.

The headset profile includes a short press of the call button 38 and speaking a name or command to dial by voice, pressing and holding the call button 38 to redial the last called number, making a short press of the call button 38 while the call is connected to transfer the call from the phone to the eyewear, and pressing the call button 38 twice to transfer the call from the eyewear to the phone.

The controlling music profile includes pulling down the right-hand side speaker 22 (FIG. 3) to turn the eyewear 10 on, pressing the play/pause button 32 (FIG. 1) to play music or to pause/resume music, pressing and holding the play/pause button 32 to stop the music, pressing the fast forward/next song button 30 to skip to the next song, press the fast backward/previous song button 34 to play the previous song, press the volume up button 36 to increase the volume, press the volume down button 40 to decrease the volume, press and hold the fast backward/previous song button 34 and then press the right retractable button 42 on temple bar 14 to turn the eyewear off. To make or receive a call, the call button 28 is pressed, which results in the music control buttons becoming deactivated during the call. Once the call ends, the music automatically resumes from where it left off. In the event that the music player device does not support the pause the music feature in the event of an incoming call, the eyewear mutes the music when there is an incoming call.

The indicator light 48 serves as a status indicator by its display and timing of red, amber and green lights from light emitting diodes (LEDs). Circuitry governs the color sequence displayed by the indicator light 48 in correspondence with the happening of certain events. The LEDs may be used: one is red, another is green and the last is amber (or yellow).

For pairing, the indicator light 48 shows a steady red light. When pairing in successful, the indicator light 48 flashes a green light four times. When charging, the indicator light 48 shows a steady red light. When charging is complete, the LED light goes off. When idle because the eyewear is not connected to any device, the indicator light 48 flashes a red light with a longer delay between flashes than in other modes. When powering up the eyewear the indicator light 48 flashes red, amber, green, green. When powering down, the indicator light 48 flashes green, amber, red, red. While wirelessly connected to a phone/music device, the indicator light flashes green three times when 100 to 67% of the battery power life remaining, flashes amber three time when 66% to 34% of the battery power life remaining, flashes green three time when 33% to 0% of the battery power life remaining.

An audio indicator may be provided to provide voice prompts. The audio prompts may arise to signify the following events: power on, power off, Bluetooth pairing is successful, 10% of battery life remaining, power on and bonded but not connected, transfer voice from phone to eyewear, transfer voice from eyewear to phone, cancel voice dial, incoming call, identity call ID, incoming call answered, answer call waiting and hold first call, end on-going and outgoing calls, reject incoming call or reject call waiting and sustain active call, redial last dialed number, muted microphone every 10 seconds, un-mute microphone, language selection of prompts (in native language). The voice prompts for these events may be, respectively, “hello:”, “goodbye”, “pairing successful”, “battery low”, “connected”, “transfer to eyewear”, “transfer to phone”, “cancel”, “ring tone playing”, “digits said”, “call accepted”, “answer call waiting”, “end call”, “call rejected”, “redial”, “muted”, “un-mute”, “English” in English or “Russian” in Russian etc.

To toggle the language to be selected, press the previous song button 34 and volume down button 40. The default language may be English. The following terminology applies to this application:

(1) Eyewear

Although eyewear is defined as a vision aid or similar device worn over the eyes, such as eyeglasses, contact lenses or protective goggles, the term “eyewear” in this application will refer to any vision aid or similar device worn over the eyes excluding contact lenses. That is, eyewear includes, but not limited to, glasses (eyeglasses or spectacles), protective goggles, sunglasses, face shields and masks.

(2) Glasses

Glasses, also called eyeglasses or spectacles, are frames bearing lenses worn in front of the eyes, normally for vision correction, eye protection, or for protection from UV rays. Modern glasses are typically supported by pads on the bridge of the nose and by temples placed over the ears. Historical types include the pince-nez, monocle, and lorgnette.

Eyeglass frames are commonly made from metal or plastic. Lenses were originally made from glass, but many are now made from various types of plastic, including CR-39 and polycarbonate. These materials reduce the danger of breakage and weigh less than glass lenses. Some plastics also have more advantageous optical properties than glass, such as better transmission of visible light and greater absorption of ultraviolet light. Some plastics have a greater index of refraction than most types of glass; this is useful in the making of corrective lenses shaped to correct various vision abnormalities such as myopia, allowing thinner lenses for a given prescription. Newer plastic lenses, called izon, can also correct for the higher order abberations that naturally occur in the surface of our eye. These lenses create sharper vision and help with the halos, starbursts, and comet-tails often associated with night time driving glare.

Scratch-resistant coatings can be applied to most plastic lenses giving them similar scratch resistance to glass. Hydrophobic coatings designed to ease cleaning are also available, as are anti-reflective coatings intended to improve night vision and make the wearer's eyes more visible.

CR-39 lenses are the most common plastic lenses due to their low weight, high scratch resistance, and low transparency for ultra violet and infrared radiation. Polycarbonate and Trivex lenses are the lightest and most shatter-resistant, making them the best for impact protection, yet offer poor optics due to high dispersion, and having a low Abbe number of 31.

Not all glasses are designed solely for vision correction but are worn for protection, viewing visual information (such as stereoscopy) or simply just for aesthetic or fashion values. Safety glasses are a kind of eye protection against flying debris or against visible and near visible light or radiation. Sunglasses allow better vision in bright daylight, and may protect against damage from high levels of ultraviolet light.

(3) Goggles or Safety Glasses

Goggles or safety glasses are forms of protective eyewear that usually enclose or protect the eye area in order to prevent particulates, water or chemicals from striking the eyes. They are used in chemistry laboratories and in woodworking. They are often used in snow sports as well, and in swimming. Goggles are often worn when using power tools such as drills or chainsaws to prevent flying particles from damaging the eyes. Many types of goggles are available as prescription goggles for those with vision problems. The requirements for goggles varies depending on the use. Some examples:

Cold weather: Most modern cold-weather goggles have two layers of lens to prevent the interior from becoming “foggy”. With only a single lens, the interior water vapor condenses onto the lens because the lens is colder than the vapor, although anti-fog agents can be used. The reasoning behind dual layer lens is that the inner lens will be warm while the outer lens will be cold. As long as the temperature of the inner lens is close to that of the interior water vapor, the vapor should not condense. However, if water vapor gets between the layers of the lens, condensation can occur between the lenses and is almost impossible to get rid of, thus, properly constructed and maintained dual-layer lenses should be air-tight to prevent water vapor from getting in between the lenses.

Swimming: Must be watertight to prevent water, such as salt water when swimming in the ocean, or chlorinated water when swimming in a pool, from irritating the eyes or blurring vision. Allows swimmers to see clearly underwater. They will not be usable more than a few feet underwater, because the water pressure will press them tightly against the face. Examples of these include the Swedish goggles.

Power tools: Must be made of an unbreakable material that prevents chunks of metal, wood, plastic, concrete, and so on from hitting or piercing the eye. Usually has some sort of ventilation to prevent sweat from building up inside the goggles and fogging the surface.

Blowtorch goggles: These protect the eyes from glare and flying sparks and hot metal splashes while using or near as blowtorch. They are not dark enough for arc welding.

Motorcycle riding and other open-air activities: Prevents insects, dust, and so on from hitting the eyes.

Laboratory and research: Combines impact resistance with side shields to prevent chemical splashes reaching the eyes. May also include laser protection, which would be covered by EN 207 (Europe) and ANSI Z 136 (United States).

Examples of these include red adaptation goggles.

Racquetball: Protect the eyes from racquets swinging in an enclosed area and from impact from hard rubber ball.

Winter sports: Protect the eyes from glare and from icy particles flying up from the ground.

Astronomy and meteorology: dark adaptor goggles are used before going outside at night, in order to help the eyes adapt to the dark.

Basketball: Several NBA players have worn goggles during play. They prevent a fellow player from scratching or hitting the eyes when trying to grab the basketball.

Aviation: In open cockpit aircraft, similar to biplanes, aviators would wear goggles to help protect from the wind and are still in use today. Examples of these include the AN-6530 goggles.

Virtual reality: A virtual reality headset, sometimes called “goggles”, is a wrap-around visual interface to display computer output. Commonly the computer display information is presented as a three-dimensional representation of real-world environments.

(4) Night Glasses

Night glasses are telescopes or binoculars with a large diameter objective. Large lenses can gather and concentrate light, thus intensifying light with purely optical means and enabling the user to see better in the dark than with naked eye alone. Often night glasses also have a fairly large exit pupil of 7 mm or more to let all gathered light into the user's eye. However, many people can't take advantage of this because of the limited dilation of the human pupil. To overcome this, atropine eye drops may be taken to dilate pupils.

(5) Face Masks

Face masks include protective masks, occupational masks and sports masks. Protective masks are pieces of kit or equipment worn on the head and face to afford protection to the wearer, and today usually have these functions, namely, providing a supply of air or filtering the outside air and protecting the face against flying objects or dangerous environments, while allowing vision.

Occupational masks include a filter mask, a piece of safety equipment, a gas mask, a mask worn on the face to protect the body from airborne pollutants and toxic materials, a beaked mask containing herbs in the beak, a full-face mask as part of self-contained breathing apparatus for divers and others; some let the wearer talk to others through a built-in communication device, an oxygen mask worn by high-altitude pilots, or used in medicine to deliver oxygen, anesthetic, or other gases to patients, a welding mask to protect the welder's face and eyes from the brightness and sparks created during welding.

Sports masks include a fencing mask, an ice hockey goalkeeper's mask, a baseball catcher's mask, a balaclava, also known as a “ski mask”, to protect the face against cold air, diving mask, an item of diving equipment that allows scuba divers, free-divers, and snorkelers to see clearly underwater, a goalie mask, a mask worn by an ice or field hockey goaltender to protect the head from injury, a visor (ice hockey), and a paintball mask.

(6) Bluetooth

Bluetooth connectivity involves connection with a wireless protocol utilizing short-range communications technology facilitating data transmission over short distances from fixed and/or mobile devices, creating wireless personal area networks (PANs). The intent behind the development of Bluetooth was the creation of a single digital wireless protocol, capable of connecting multiple devices and overcoming issues arising from synchronization of these devices.

Bluetooth provides a way to connect and exchange information between devices such as mobile phones, telephones, laptops, personal computers, printers, GPS receivers, digital cameras, and video game consoles over a secure, globally unlicensed Industrial, Scientific, and Medical (SM) (2.4 GHz short-range radio frequency bandwidth.

The wireless Bluetooth connectivity in accordance with the present invention relies upon transceiver circuitry, switches, batteries, one or two speakers and one or two microphones (although any number of microphones and speakers may be used). The present invention is preferably configured or operates in accord with any or all of the following criteria.

(1) Arrange the transceiver circuitry within the frame of eyewear in a non-embedded manner, such as clipped in. That way, the transceiver circuitry may be inserted or taken out of the frame without damaging the frame itself.

(2) Power both speakers from a common power source. This may be accomplished by placing the power source in one temple with a power line extending to both speakers. One of the speakers is preferably at the end or mid-section of the same temple that carries the power source and the other speaker is preferably at the end or mid-section of the other temple. In this manner, the power line extends through, is carried by or runs adjacent to the lens holder brow piece of the eyewear, as well as extends through, is carried by or runs adjacent to both temples. The power line may be embedded. Such a power line may convey communication signals to the speakers and/or from the microphones.

(3) Take measures to prevent the speakers from dangling from their wires or cords. For instance, the speaker wires or cords may be retractable into the hollow of the temples either under manual force or under spring tension and may wrap around a wheel. Alternatively, provide a disconnect that enables the protruding portion of the wires or cords with speakers to be disconnected from the transceiver circuitry and thereby allow the disconnected wires or cords and speakers to be tucked away into one's pocket or elsewhere.

(4) Power the microphones, speakers and transceiver with a common power source. This may require that a power line extend through or along the exterior of the lens holder browpiece from one temple to the other. If the power line is within the frame, it is hidden from view unless the frame is made of a translucent or transparent material. The transceiver and batteries could be anywhere within the frame (e.g., either temple or the lens holder brow piece).

(5) Alternatively, power each speaker independent of each other with their own respective power source. If one speaker with its power source may be detached from the eyewear, provision can be made for that one speaker to be powered (and its power supply recharged) when it is attached to the eyewear and in electrical connection with the other power supply. The speakers may be powered separately and recharged from the same power source or from multiple rechargers (such as via multiple ports).

(6) Send communication signals to the transceiver circuitry from each of the speakers, but do not route the communication signal through the front portion of the lens holder brow piece if feasible. For instance, routing the communication signal through the rear portion of the lens holder brow piece would suffice. Otherwise, this may require providing a distal one of the speakers with its own radio frequency transmission capability to transmit its signals wirelessly to the transceiver circuitry and thereby bypass any electrical lines in the lens holder brow piece. Alternatively, it will suffice to avoid transmitting communication signals directly to the transceiver circuitry via the lens holder brow piece by employing a detector that is not in electrical connection with the distal speaker. Instead, the detector detects the presence and characteristic of the communication signal passing through either the power line or a separate communication line to send a corresponding signal of what was detected to the transceiver circuitry.

(7) Avoid a construction in which the insertion of a male connector portion into a female connector portion both releasably attaches a temple to the lens holder brow piece of the frame and establishes an electrical connection between the lens holder brow piece of the frame and the temple. Thus, make the electrical connection between the lens holder brow piece of the frame and the temple continuous and independent of any mechanical connection between the lens holder brow piece of the frame and the temple. Instead, have one earbud detach from the temple to operate separately via Bluetooth frequencies and can attach to work with the circuitry in the eyewear.. Such an earbud can operate independently with its own transmitter and speaker. In either, it works with an MP3 player.

(8) Avoid the use of ball joints to connect with the speakers. Instead, use a retractable cord that winds about a wheel under spring bias and unwinds by a manual pulling force to reach an extended position. The end of the cord is attached to a speaker. The cord remains in the extended position until the wheel is activated to wind the cord and thereby move the speaker into the retracted position. The pulling out of the speakers may trigger activation of the transceiver circuitry and the retraction of the speakers may trigger deactivation of the transceiver circuitry. The cord operation may correspond to conventional retractable power cords commonly found in appliances. Alternatively, a spring can be used to pull in the speaker. The spring can be pulled out (extended) to lock into an operative position. Alternatively, any mechanism, such as a magnet or clip may be used instead of a spring by manual operation. If desired a tube or channel can be provided to guide the speaker wire.

(9) Configure the eyewear so that there are no linkages that cover part of the wearer's head between the ear and the front of the face and thus do not detract aesthetically when the wearer is wearing fashion apparel. In addition, the wearer can swing the eyewear off the eyes and onto the top of the head while keeping the speakers in the ears and thereby carry on a conversation through transceiver circuitry within the eyewear temples. Further, when the eyewear is on top one's head, music from the speakers can be heard perfectly nonetheless. That is, music can be heard in stereo or mono while substantially just as well as if the eyewear were resting on the nose. Speech can be heard as well with the eyewear on top of one's head.

An advantage attributed to having two microphones or more is the ability to have multiple unidirectional microphones, multiple omni-directional microphones, or a combination of unidirectional microphones and omni-directional microphones. For instance, a unidirectional microphone might be enabled while a wearer is having a personal conversation via Bluetooth communications through a cell phone. An omni-directional microphone might be enabled while the wearer is at a concert to allow the music from the concert to be picked up by the omni-directional microphone for transmission via Bluetooth communications through a cell phone.

In addition, superior noise cancellation capability may be realized with multiple microphones as opposed to relying upon just a single microphone. The microphone signals may pass via or through the lens holder brow piece to the circuit board in the temple.

The circuit board is flexible, which provides an advantage of bending without breaking. The flexible circuit board extends from the two temples through the lens holder brow piece.

The speakers may be retractable into the temple to turn off the transceiver circuitry and extendable out to turn on the transceiver circuitry. Such is advantageous in avoiding the need for a separate on/off switch since retracing or extending out the speakers performs the on/off function.

The pairing of the present inventive eyewear with a Bluetooth enabled device may be with any compatible communication device, such as cell phone, MP3 music player, walkie talkie, personal digital assistant, internet-connected multimedia smartphone, combination camera phone, PDA, multimedia player and wireless communication device.

In the case of the walkie-talkie or two-way radio communication, it would be helpful to convert one of the control buttons of the present inventive eyewear (or add a further control button) that operates in a Push-to-Talk (PTT) manner (also referred to as Push-to-Transmit). Such a button acts as a momentary button to switch from voice reception mode to transmit mode for conversing on half-duplex communication. That is, PTT calls are half duplex communications—while one person speaks, the other(s) listen. Traditional mobile phone networks and devices utilize full-duplex communications, allowing customers to call other persons on a mobile or land-line network and be able to simultaneously talk and hear the other party. Such communications require a connection to be started by dialing a phone number and the other party answering the call, and the connection remains active until either party ends the call or the connection is dropped due to signal loss or a network outage. Such a system does not allow for casual transmissions to be sent to other parties on the network without first dialing them up, as is provided by two-way radios. Full-duplex operation on mobile phone networks is made possible by using separate frequencies for transmission and reception.

Mobile Push-to-Talk service, offered by some mobile carriers, adds functionality for individual half-duplex transmissions to be sent to another party on the system without needing an existing connection to be already established. Since the system is half-duplex (utilizing a single frequency), only one user can transmit by PTT at a time; the other party is unable to transmit until the transmitting user unkeys their PTT button.

If desired, a key fob or other kind of accessory handheld device may be used to turn on the eyewear communication electronics of the present invention remotely and/or t provide the same functions corresponding to those of the control buttons on the eyewear. Such an accessory handheld device may be equipped with the same number of buttons as the eyewear so as to provide a one-to-one correspondence. Alternatively, it may have fewer buttons or even just one to provide just some or all of the functions otherwise carried out with the full complement of control buttons of the eyewear. With fewer buttons, the accessory handheld device may need to rely upon pressing the buttons it does have in a particular order and/or in accordance with timing of the button press (e.g., pressing the button for a relatively short, momentary time or for a longer interval) to increase the number of functions it can be used to carry out through a unique combination of button presses.

If desired, the control buttons may be supplemented or replaced by sensors that respond to sliding motion of one's finger along the eyewear frame or to heat generated by the human finger in close proximity to the eyewear frame.

While the foregoing description and drawings represent the preferred embodiments of the present invention, it will be understood that various changes and modifications may be made without departing from the spirit and scope of the present invention. Indeed, sensors may be provided to sense rapid eyelid movements of both eyes simultaneously or one after the other and to treat them as commands for carrying out functions otherwise performed by the control buttons or activating or turning off the eyewear, depending upon the sequence of timing of the eye movements.

What is claimed is:

1. An eyewear apparatus, comprising an eyewear frame that includes two temples and a lens holder that extends between the two temples, at least two microphones spaced apart from each other on or within the eyewear frame, at least one speaker, a mechanism within confines of the eyewear frame and operative to enable the at least one speaker to move between a retracted position and an extended position, the at least one speaker being further from the eyewear frame in the extended position than in the retracted position, an integrated circuit within the eyewear frame that has noise cancellation software suited to cancel extraneous background noise picked up from the at least two microphones and has wireless connectivity to effect wireless communication with at least one device remote from the eyewear frame, a power source arranged within confines of the eyewear frame to power the integrated circuit and the at least two microphones and the at least one speaker.

2. The eyewear apparatus of claim 1, wherein the at least one of the at least two microphones are recessed within the eyewear frame.

3. The eyewear apparatus of claim 1, wherein the temples each have an inner surface that faces each other, the lens holder having a further inner surface that faces a region lying between the inner surfaces of the temples, at least one of the at least two microphones being on the eyewear frame adjacent the region.

4. The eyewear apparatus of claim 1, wherein the mechanism includes a wheel and a cord wrapped onto the wheel, the cord and the speaker being movable in unison with each other, the wheel being configured and arranged to be turned in one direction to wrap the cord onto the wheel and thereby pull the at least one speaker into the retracted position, the wheel being further configured and arranged to be turned in a direction opposite to that of the one direction to unwrap the cord from the wheel and thereby slacken the cord to enable the speaker to reach the extended position.

5. The eyewear apparatus of claim 1, wherein one of the temples has a detachable portion that is configured and arranged to mechanically and electrically detach from a remainder of the one of the temples, the detachable portion including the mechanism with cord, the at least one speaker and at least one of the at least two speakers, the detachable portion further including a further integrated circuit configured to be in wireless communication with the integrated circuit within the eyewear frame.

6. The eyewear apparatus of claim 1, further comprising user interface structures responsive to manual contact to selectively establish and break off the wireless communication.

7. The eyewear apparatus of claim 5, further comprising a detachable ear hook configured to retain the detachable portion of the one of the temples to an ear of a wearer.

8. The eyewear apparatus of claim 1, further comprising audio indicator circuitry configured to generate audio prompts to the at least one speaker upon a happening of certain events that include power up and pairing wirelessly.

9. The eyewear apparatus of claim 1, further comprising at least one indicator light arranged to emit light from the eyewear frame, further comprising circuitry configured to trigger the indicator light to emit the light in accordance with an associated one of plurality of color sequences that correspond with a happening of certain events.

10. The eyewear apparatus of claim 9, wherein the color sequence includes flashing light and steady light and includes colors selected from the group consisting of green, red, amber or yellow.
